(19) United States
(12) Patent Application Publication
(10) Pub. No.: US 2019/0125607 A1
(43) Pub. Date: May 2, 2019

(54) Treatment Sleeve System

(71) Applicant: Elizabeth M. Pepe, Indian Harbour Beach, FL (US)

(72) Inventor: Elizabeth M. Pepe, Indian Harbour Beach, FL (US)

(21) Appl. No.: 15/795,489

(22) Filed: Oct. 27, 2017

(51) Int. Cl. A61H 1/00

(52) U.S. Cl. CPC A61H 1/006; A61H 2201/1635; A61H 2201/164; A61H 2201/10; A61H 2205/102; A61H 2205/06; A61H 2201/165

(57) ABSTRACT

A treatment sleeve system which helps to both prevent and treat chaffing, callouses, and pressure sores on or around dormant joints. The treatment sleeve system generally includes a sleeve which is worn around a limb to both treat and prevent complications such as pressure sores or the like. The sleeve includes a first end having a first opening, a second end having a second opening, and a channel extending between the first and second ends. The sleeve may comprise a bend portion which is adapted to be positioned over a joint. A cavity either within the sleeve or within a holder adapted to be removably connected within the sleeve stores a volume of a composition such as an antimicrobial ointment or the like. In such a manner, the composition may be applied to an affected area such as a wound or surgical site while the sleeve is worn on the limb.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a treatment sleeve system which helps to both prevent and treat chaffing, callouses, and pressure sores on or around dormant joints.

### Related Art

Any discussion of the related art throughout the specification should in no way be considered as an admission that such related art is widely known or forms part of common general knowledge in the field.

Both humans and animals such as dogs, horses, cats, and the like are commonly subjected to surgical procedures which can have lengthy recovery times. During these recovery times, various complications can arise from the lack of movement while such a human or animal is spending long dormant period healing. For example, chaffing, callouses, and pressure sores may form if the surgical site is not properly treated or if the joints are not properly cared for during long dormant periods of time.

In the past, surgical dressings are typically applied and care must be made to move the patient around to prevent such complications. While limb sleeves have been used in the past, they typically do not include any feature which serves to treat pressure sores and the like, or to apply any type of composition to a wound or surgical area. While such limb sleeves may provide some comfort and prevent unwanted movement of the limb, it would be preferable to include a feature which acts to both treat and prevent any complications such as thin skin, pressure sores, or the like.

### SUMMARY

An example embodiment is directed to a treatment sleeve system. The treatment sleeve system includes a sleeve which is worn around a limb to both treat and prevent complications such as pressure sores or the like. The sleeve includes a first end having a first opening, a second end having a second opening, and a channel extending between the first and second ends. The sleeve may comprise a bend portion which is adapted to be positioned over a joint. A cavity either within the sleeve or within a holder adapted to be removably connected within the sleeve stores a volume of a composition such as an antimicrobial ointment or the like. In such a manner, the composition may be applied to an affected area such as a wound or surgical site while the sleeve is worn on the limb.

There has thus been outlined, rather broadly, some of the embodiments of the treatment sleeve system in order that the detailed description thereof may be better understood, and in order that the present contribution to the art may be better appreciated. There are additional embodiments of the treatment sleeve system that will be described hereinafter and that will form the subject matter of the claims appended hereto. In this respect, before explaining at least one embodiment of the treatment sleeve system in detail, it is to be understood that the treatment sleeve system is not limited in its application to the details of construction or to the arrangements of the components set forth in the following description or illustrated in the drawings. The treatment sleeve system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a treatment sleeve system in accordance with an example embodiment illustrating a composition holder.

FIG. 2 is a side view of a treatment sleeve system in accordance with an example embodiment.

FIG. 3 is a rear view of a treatment sleeve system in accordance with an example embodiment.

FIG. 4 is a side sectional view of a treatment sleeve system in accordance with an example embodiment.

FIG. 5 is a first end view of a treatment sleeve system in accordance with an example embodiment.

FIG. 6 is a second end view of a treatment sleeve system in accordance with an example embodiment.

FIG. 7 is a perspective view of a treatment sleeve system in accordance with an alternate embodiment illustrating a composition holder.

FIG. 8 is a side view of a treatment sleeve system in accordance with an alternate embodiment.

FIG. 9 is a rear view of a treatment sleeve system in accordance with an alternate embodiment.

FIG. 10 is a side sectional view of a treatment sleeve system in accordance with an alternate embodiment.

FIG. 11 is a first end view of a treatment sleeve system in accordance with an alternate embodiment.

FIG. 12 is a second end view of a treatment sleeve system in accordance with an alternate embodiment.

FIG. 13 is a perspective view of a treatment sleeve system being worn by a dog in accordance with an example embodiment.

FIG. 14 is a perspective view of a treatment sleeve system being worn by a horse in accordance with an example embodiment.

### DETAILED DESCRIPTION

### A. Overview

An example treatment sleeve system generally comprises a sleeve 20 which is worn around a limb to both treat and prevent complications such as pressure sores or the like. The sleeve 20 includes a first end 21 having a first opening 22, a second end 23 having a second opening 24, and a channel 25 extending between the first and second ends 21, 23. The sleeve 20 may comprise a bend portion 34 which is adapted to be positioned over a joint. A cavity 42 either within the sleeve 20 or within a holder 40 adapted to be removably connected within the sleeve 20 stores a volume of a composition 44 such as an antimicrobial ointment or the like. In such a manner, the composition 44 may be applied to an affected area such as a wound or surgical site while the sleeve 20 is worn on the limb.

While the figures illustrate the use of the sleeve 20 on animals such as a horse and a dog, it should be appreciated that the sleeve 20 could similarly be worn by humans and other animals such as cats. The sleeve 20 should not be construed as limited in its application by the exemplary figures and descriptions herein. The sleeve 20 could be used to treat a wide range of body parts and could be utilized on humans or animals.

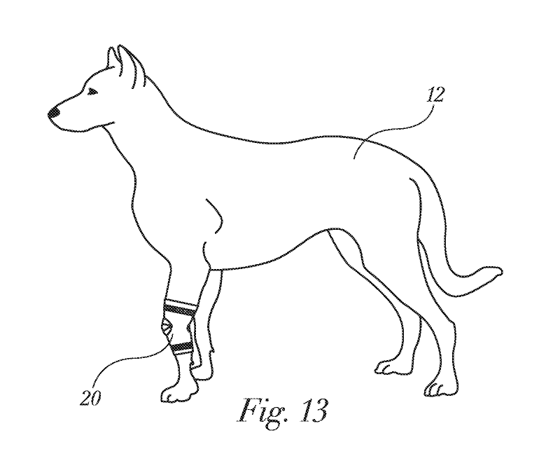

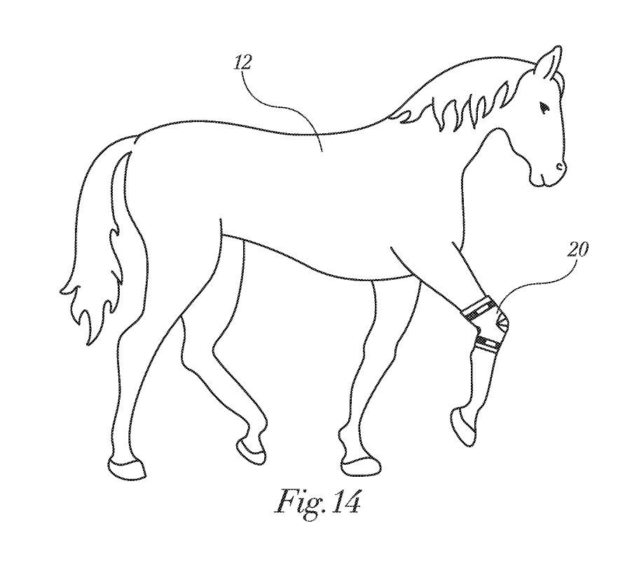

FIG. 13 illustrates a sleeve 20 being worn on a front limb of an animal 12 comprised of a dog. FIG. 14 illustrates a sleeve 20 being worn on a front limb of an animal comprised of a horse. It should be appreciated that any type of animal may benefit from the sleeve 20. Applications of the sleeve 20 should not be construed as limited to any specific animal. Further, it should be appreciated that the sleeve 20 may be connected to any limbs. Although the figures illustrate the sleeves 20 on front limbs, they could just as easily be used on the rear limbs of the shown animals 12.

### B. Sleeve

As shown throughout the figures, a sleeve 20 is provided which may be temporarily worn around a limb such as an arm or leg to both treat and prevent complications from surgeries, wounds, chronic pain such as arthritis, or long periods of dormant rest. It should be appreciated that the shape, size, and configuration of the sleeve 20 may vary in different embodiments.

The material used for the sleeve 20 may vary; with some sleeves 20 being rigid and other sleeves 20 being flexible. An exemplary material would be a soft fabric or a rubber such as neoprene, though a wide range of other materials could be utilized. In some embodiments, the material may comprise a material which discourages animals from chewing on the sleeve. In other embodiments, the sleeve 20 may be treated with a spray or other substance designed to produce the same effect—preventing an animal from chewing, licking, or otherwise affecting the sleeve 20.

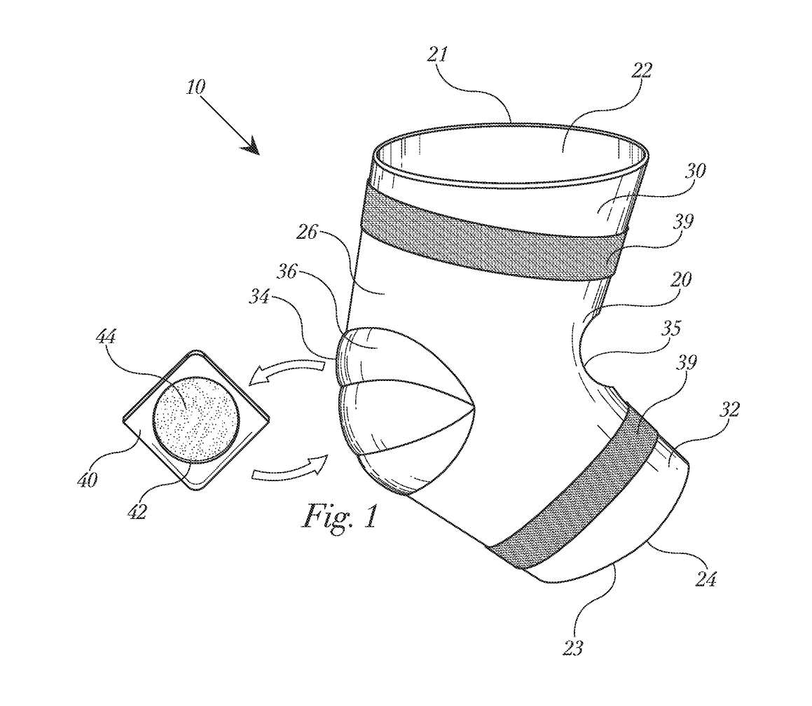

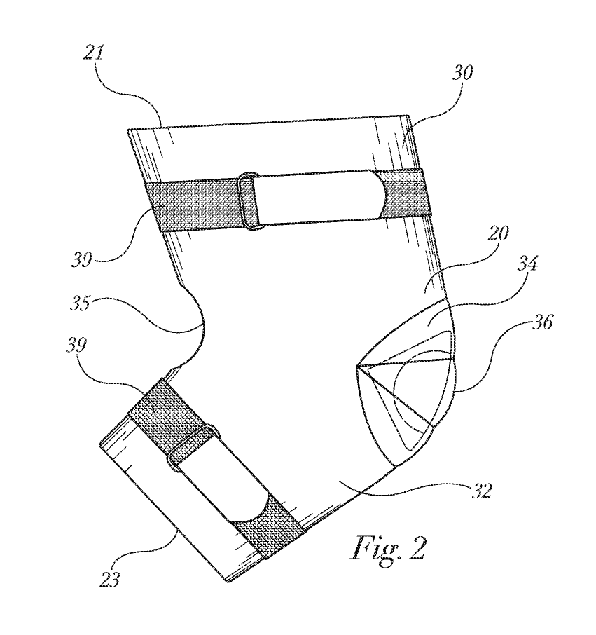

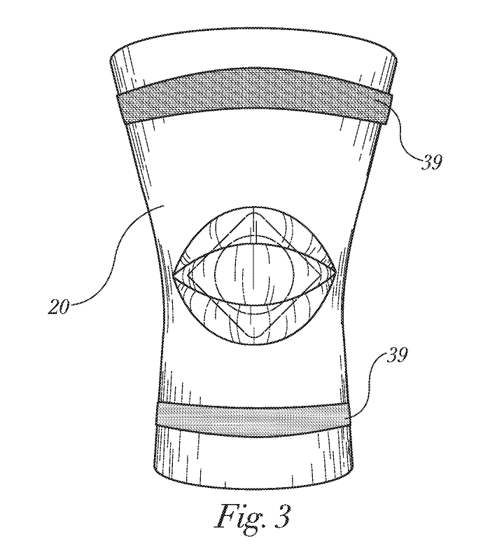

As shown in FIGS. 1-3, the sleeve 20 may include a first end 21 having a first opening 22 and a second end 23 having a second opening 24. Although the figures illustrate that the first opening 22 is larger than the second opening 24, the reverse configuration could be utilized in some embodiments. In other embodiments, the size of the first and second openings 22, 24 may be the same. A limb will generally be inserted through the first opening 22 and then through the second opening 24, but other configurations may be utilized in different embodiments.

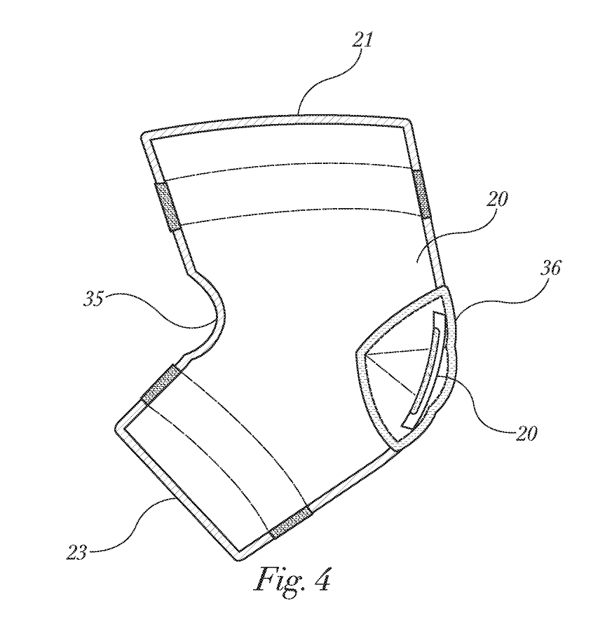

As shown in FIGS. 4-6, a channel 25 may extend through the sleeve 20 between its first end 21 and its second end 23. The channel 25 may narrow between the first opening 22 and the second opening 24 as shown in the figures. In other embodiments, the channel 25 may widen between the first and second ends 21, 23 of the sleeve 20 or may maintain a uniform circumference. The affected limb is generally positioned within the channel 25 of the sleeve 20 when the sleeve 20 is worn.

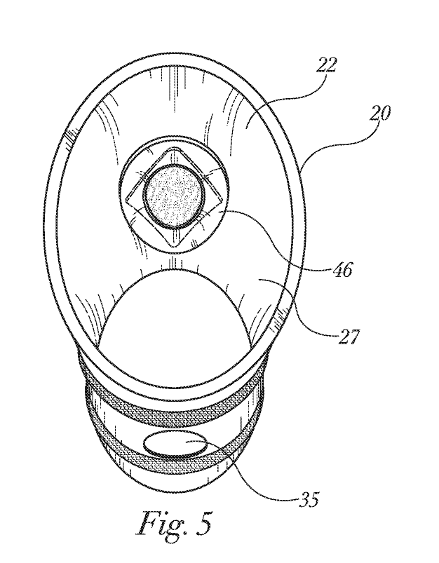

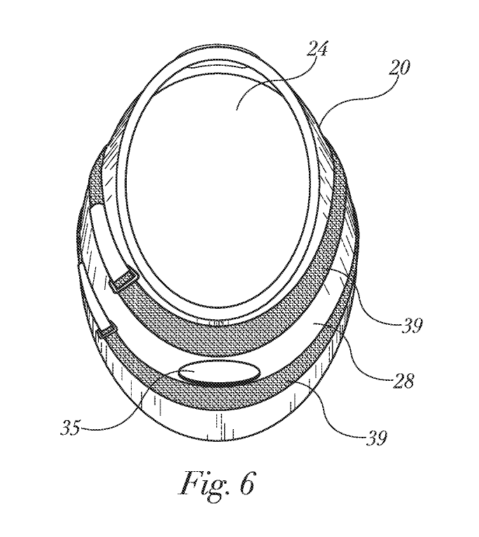

As best shown in FIGS. 5 and 6, the sleeve 20 may comprise an outer surface 26 and an inner surface 27. The outer surface 26 of the sleeve 20 faces away from the limb and may include securing members 39 such as straps, hook-and-loop fasteners, and the like which are utilized to tighten the sleeve 20 around the limb. The inner surface 27 of the sleeve 20 contacts the affected limb and may include a cavity 42 adapted to store a composition 44 such as an antibiotic ointment or the like which is applied by the sleeve 20 to the limb when the sleeve 20 is worn.

As shown throughout the figures, the sleeve 20 may comprise a first portion 30 and a second portion 32 separated by a bend portion 34. This configuration is particularly suitable for treatment of joints, such as elbows or knees, with the joint being positioned within the bend portion 34 of the sleeve 20. In some embodiments, the bend portion 34 may be omitted; with the sleeve 20 being linear without any curves or bends.

The first portion 30 will generally extend form the first end 21 of the sleeve 20 to the bend portion 34. The first portion 30 of the sleeve 20 includes the first opening 22 which leads to the channel 25. The second portion 32 of the sleeve 20 generally extends from the bend portion 34 to the second end 23 of the sleeve 20. In embodiments which are linear, the first portion and second portion 30, 32 will be directly connected to each other.

In the embodiments shown in the figures, the first portion 30 is wider than the second portion 32. In alternate embodiments, the reverse could be true; with the first portion 30 being narrower than the second portion 32. In other embodiments, the first and second portion 30, 32 could be of uniform width.

The first portion 30 is generally worn on a first side of a joint, the second portion 32 is generally worn on a second side of the joint, and the bend portion 34 is generally worn over the joint. For example, if the sleeve 20 were worn on an arm, the first portion 30 would cover the biceps, the bend portion 34 would cover the elbow, and the second portion 32 would cover the forearm. As another example, if the sleeve 20 were worn on a leg, the first portion 30 would cover the thigh, the bend portion 34 would cover the knee, and the second portion 32 would cover the calf.

As shown in FIGS. 1, 2, and 4-6, the sleeve 20 may include a cutout portion 35 which is on the cutout portion 35 that is positioned to cover the fossa for example if the sleeve 20 is worn on a knee. The cutout portion 35 comprises an opening in the sleeve 20 at its bend portion 34. The cutout portion 35 prevents pressure sores or other discomfort which would be caused by crimping or folding of the sleeve 20 over that portion of the body. If worn on an elbow, the cutout portion 35 would be on the side of the arm opposite the elbow. The cutout portion 35 may be elliptically-shaped as shown in the figures or may be other shapes such as circular or the like.

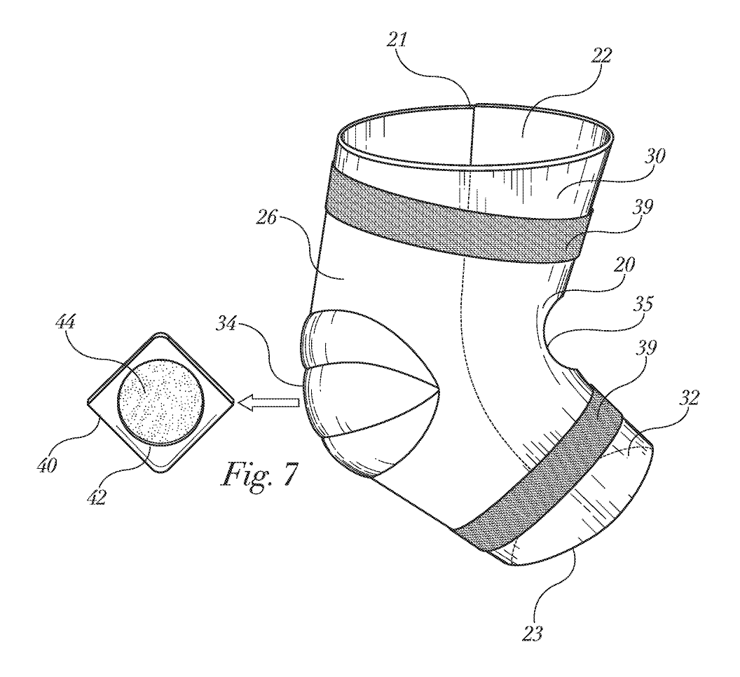

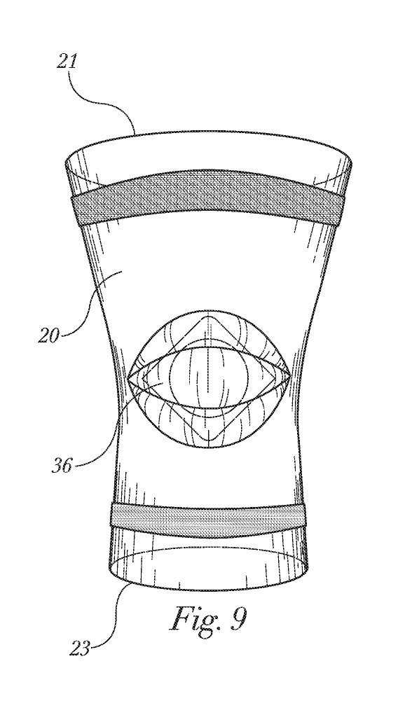

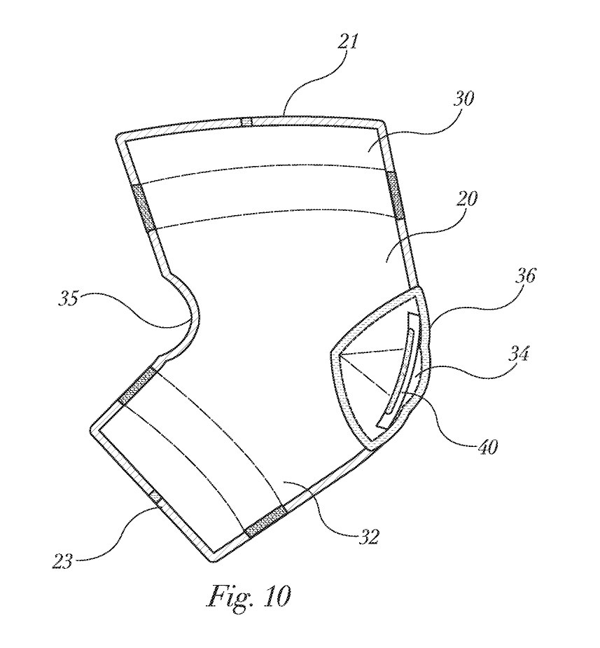

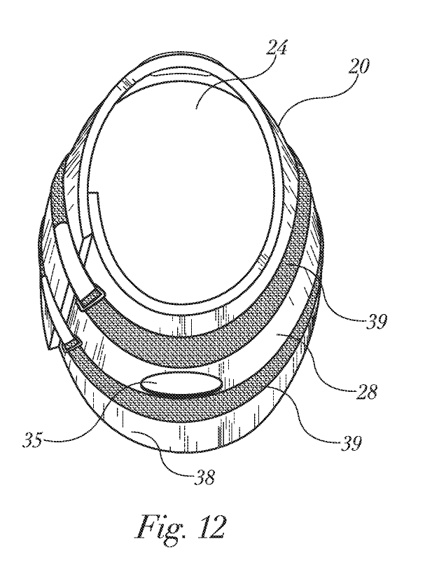

FIGS. 1-6 illustrate a sleeve 20 which is pulled over the limb. FIGS. 7-12 illustrate an alternate embodiment of the sleeve 20 which includes a slot 38 extend its length. In such an alternate embodiment, the sleeve 20 may wrapped around the limb rather than having the limb inserted through the sleeve 20. The two halves of the sleeve 20 may then be combined to close the slot 38 and secure the sleeve 20 around the limb. In the figures, the slot 38 is shown as being on the outside of the limb on which the sleeve 20 is worn. It should be appreciated that the orientation and positioning of the slot 38 should not be construed as limited by the exemplary figures as alternate positioning or orientation may be utilized for different purposes.

As shown throughout the figures, the sleeve 20 may include one or more securing members 39 which tighten the sleeve 20 around the limb. In a preferred embodiment, straps and corresponding hook-and-look fasteners may be utilized such as shown in the figures. In other embodiments, clasps, buttons, zippers, or other configurations may be utilized to both tighten the sleeve 20 around the limb and to keep the sleeve 20 on the limb.

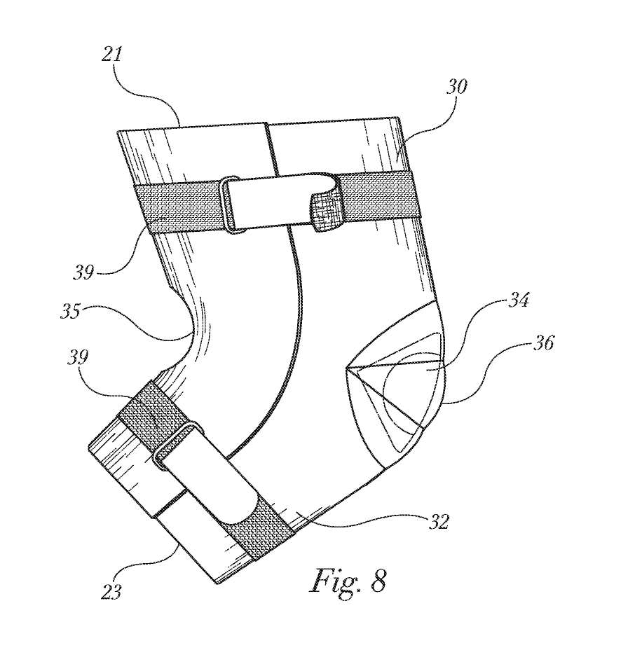

As shown in FIG. 8, the securing members 39 may comprise straps which are anchored on a first side of the slot 38 of the sleeve 20. The securing members 39 may be wrapped around the sleeve 20 and tightened with a clasp which is positioned at the anchoring point of the securing members 39. After being looped through the clasp, the securing members 39 may be tightened and attached to the sleeve 20 or the securing members 39 themselves via hook-and-loop fasteners.

The sleeve 20 may include a cavity 42 within the channel 25 against its inner surface 27 for storing a volume of a composition 44. The cavity 42 may be formed directly within the inner surface 27 of the sleeve 20, such as by creating a depression within the wall of the inner surface 27 of the sleeve 20 in which a composition 44 may be applied such that the composition 44 contacts the limb when the sleeve 20 is worn. The composition 44 could be applied at various locations within the sleeve 20 and should not be construed as being limited to being located in the bend portion 34 as shown in the exemplary figures.

In an embodiment such as shown in FIGS. 1, 5, 7, and 11, a removable holder 40 may be utilized to hold the composition 44. The holder 40 may comprise a patch or other structure which is removably connected within the channel 25 of the sleeve 20 against its inner surface 27. The holder 40 may include a cavity 42 in which the composition 44 is stored to be applied to the limb.

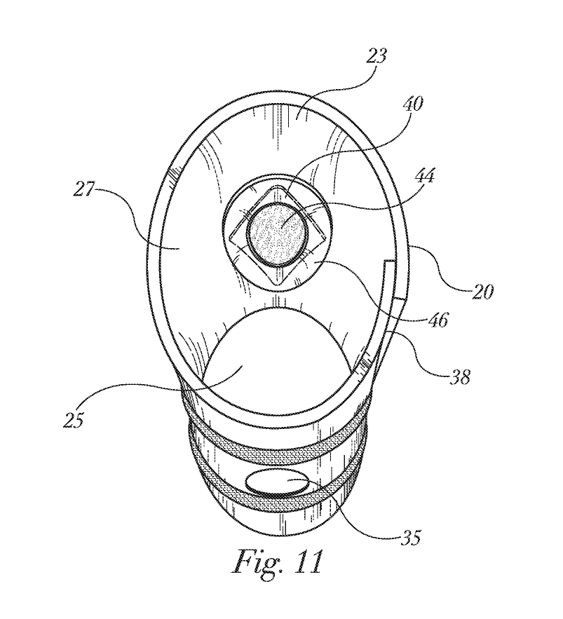

As shown in FIGS. 5 and 11, the sleeve 20 may include a retainer 46 which is adapted to removably secure the holder 40 in place. For example, a donut-shaped connector could be positioned against the inner surface 27 within the channel 25; with the holder 40 being adapted to be retained in place by the retainer 46. In the example shown in the FIG. 11, the outer edges of the holder 40 are retained by the retainer 46 while the cavity 42 with the composition 44 is exposed.

It should be appreciated that the positioning of the holder 40 within the sleeve 20 may vary in different embodiments. The exemplary figures illustrate the holder 40 being positioned within the bend portion 34 to apply the composition 44 to a joint. In different embodiments, the holder 40 could be positioned alternatively in the first or second portions 30, 32 of the sleeve 20, or in any other location as needed for treatment.

A wide range of compositions 44 may be utilized. The composition 44 could be liquid (such as a gel), solid (such as a powder) or foam. The composition 44 could comprise an antibiotic ointment, moisturizing lotions, topical analgesics, and the like. The type of composition 44 should not be construed as limited in any manner by the present disclosure.

### C. Operation of Preferred Embodiment

In use, the composition 44 is first applied to the sleeve 20 in embodiments which use such compositions 44. In embodiments in which the cavity 42 for the composition 44 is formed within the sleeve 20 itself, the composition 44 may be applied to the cavity 42 within the channel 25 such as by positioning a dispenser of the composition 44 within the sleeve 20 to apply the composition directly within the cavity 42.

In embodiments which utilize a removable holder 40 such as shown in the figures, the holder 40 is first removed from within the channel 25 of the sleeve 20. The composition 44 is applied to the cavity 42 of the holder 40 while the holder 40 is removed from the sleeve 20. The holder 40 may then be re-inserted within the channel 25 of the sleeve 20 and removably retained therein by the holder 40.

Once the composition 44 has been positioned interior to the sleeve 20, the sleeve 20 may be positioned on the affected limb. In the embodiment shown in FIGS. 1-6, the limb is inserted through either the first or second opening 22, 24 of the sleeve 20 until the sleeve 20 is fully positioned around the limb such that the cavity 42 holding the composition 44 is positioned over the affected area such as a joint. The securing members 39 may be connected such that the sleeve 20 is tightened around the limb.

In the embodiment shown in FIGS. 7-12, the sleeve 20 is wrapped around the limb rather than inserting the limb through the sleeve 20. The sleeve 20 is split by the slot 38 such that the sleeve 20 may be wrapped around the limb. The two halves of the sleeve 20 are then drawn together to close the slot 38 such that the sleeve 20 surrounds the limb. In the embodiment shown in the figures, the sleeve 20 is drawn together such that the slot 38 is on the outside of the limb being covered by the sleeve 20. The securing members 39 may be connected such that the sleeve 20 is tightened around the limb.

With the sleeve 20 in place, the affected limb will be protected from various complications as discussed previously. The composition 44 will continuously treat the affected area (such as a surgical site) to both treat and prevent such complications. When needed, the sleeve 20 may be removed to reapply a new volume of the composition 44 within the cavity 42 for further treatment.

Unless otherwise defined, all technical and scientific terms used herein have the same meaning as commonly understood by one of ordinary skill in the art to which this invention belongs. Although methods and materials similar to or equivalent to those described herein can be used in the practice or testing of the treatment sleeve system, suitable methods and materials are described above. All publications, patent applications, patents, and other references mentioned herein are incorporated by reference in their entirety to the extent allowed by applicable law and regulations. The treatment sleeve system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A treatment sleeve, comprising:
a first portion including a first opening;
a second portion including a second opening;
a channel extending between the first opening and the second opening, wherein the channel comprises an inner surface; and
a volume of a composition applied to the inner surface of the channel, wherein the composition is adapted to treat and prevent one or more complications.

2. The treatment sleeve of claim 1, further comprising a bend portion adapted to be positioned over a joint.

3. The treatment sleeve of claim 2, wherein the bend portion is positioned between the first portion and the second portion.

4. The treatment sleeve of claim 1, wherein the channel includes a cavity adapted to store the volume of the composition.

5. The treatment sleeve of claim 1, further comprising a holder adapted to be removably connected within the channel.

6. The treatment sleeve of claim 5, wherein the holder comprises a cavity adapted to store the volume of the composition.

7. The treatment sleeve of claim 1, wherein the composition comprises a liquid.

8. The treatment sleeve of claim 7, wherein the composition comprises an antibiotic.

9. The treatment sleeve of claim 1, wherein the composition comprises a solid.

10. The treatment sleeve of claim 1, wherein the first portion is wider than the second portion.

11. A treatment sleeve system, comprising:
a sleeve adapted to be worn on a limb, the sleeve comprising:
a first portion including a first opening;
a second portion including a second opening;
a bend portion between the first portion and the second portion, wherein the bend portion comprises a cutout portion;
a channel extending between the first opening and the second opening, wherein the channel comprises an inner surface; and
a volume of a composition applied to the inner surface of the channel, wherein the composition is adapted to treat and prevent one or more complications of the limb.

12. The treatment sleeve system of claim 11, wherein the volume of the composition is applied to the channel at the bend portion.

13. The treatment sleeve system of claim 11, wherein the channel includes a cavity adapted to store the volume of the composition.

14. The treatment sleeve of claim 11, further comprising a holder adapted to be removably connected within the channel.

15. The treatment sleeve system of claim 14, wherein the holder comprises a cavity adapted to store the volume of the composition.

16. The treatment sleeve system of claim 11, wherein the composition comprises a moisturizing lotion.

17. The treatment sleeve of claim 11, wherein the limb comprises a leg.

18. The treatment sleeve system of claim 11, wherein the composition comprises a foam.

19. The treatment sleeve system of claim 11, wherein the first opening is wider than the second opening.

20. The treatment sleeve system of claim 11, further comprising a slot extending across the first portion, the second portion, and the bend portion.
